(19) United States
(12) Patent Application Publication
(10) Pub. No.: US 2025/0362932 A1
(43) Pub. Date: Nov. 27, 2025

(54) CONFIGURATION CHANGE SUPPORT APPARATUS AND CONFIGURATION CHANGE SUPPORT METHOD

(71) Applicant: Hitachi Vantara, Ltd., Yokohama-shi (JP)

(72) Inventors: Satoshi KANEKO, Tokyo (JP); Hiro TANAKA, Tokyo (JP)

(73) Assignee: Hitachi Vantara, Ltd., Yokohama-shi (JP)

(21) Appl. No.: 19/087,822

(22) Filed: Mar. 24, 2025

(30) Foreign Application Priority Data
May 22, 2024 (JP) 2024-083070

(51) Int. Cl. G06F 9/445

(52) U.S. Cl. CPC G06F 9/44505

(57) ABSTRACT

A configuration general management server includes a storage device and a processing device. The storage device stores IT infrastructure configuration information indicating physical connections and logical connections and arrangement information of resources constituting the IT infrastructure, and application dependency information indicating dependency of an application being executed by a host on the IT infrastructure. The processing device acquires configuration change information, creates additional configuration change information to minimize an effect on the application if a configuration change based on the configuration change information is made, according to the configuration change information, the IT infrastructure configuration information, and the application dependency information, creates an application effect element indicating an effect on the application if a configuration change based on the configuration change information and the additional configuration change information is made, and notifies a configuration change maker of the application effect element and the additional configuration change information.

### BACKGROUND OF THE INVENTION

### 1. Field of the Invention

The present invention relates to a configuration change support apparatus and a configuration change support method.

### 2. Description of the Related Art

Recent information technology (IT) infrastructures are formed by a stack of a plurality of virtual techniques including a storage layer, a virtual machine (VM) layer, a container layer, and the like. Infrastructure managers of the respective layers basically do not recognize the configuration of layers other than the layers of which the respective infrastructure managers are in charge. Meanwhile, in storage plugin for containers or the like, it is necessary to describe storage configuration information as application setting information provided by a storage manager. When a configuration change such as a VM migration is made without recognizing such setting information, a problem that, for example, the system environment is destroyed even if a resource on a VM is properly migrated occurs.

In a method of JP-2019-525302-T, configuration information is automatically discovered, and, when at least one configuration component is migrated, part of configuration information indicating a connection relation to be held for the component to be migrated is provided to a migration service provider, and then, each configuration component is migrated.

### SUMMARY OF THE INVENTION

In JP-2019-525302-T, when a configuration component is migrated, configuration information indicating a connection relation in an infrastructure to be held is provided, but reference to application setting information is not made. That is, JP-2019-525302-T does not provide a method for a case where an action of changing application setting information is required due to a configuration change in an infrastructure layer (VM layer, storage layer).

Therefore, an object of the present invention is to provide a technology of supporting a configuration change in an IT infrastructure.

In order to solve the above problem, one representative configuration change support apparatus according to the present invention supports a configuration change in an IT infrastructure including one or more storage apparatuses and one or more hosts each connected with the storage apparatus. The configuration change support apparatus includes a storage device, and a processing device. The storage device stores IT infrastructure configuration information indicating physical connection and logical connection in the IT infrastructure and arrangement information of resources constituting the IT infrastructure, and application dependency information indicating dependency of an application being executed by the host on the IT infrastructure. The processing device acquires configuration change information on the IT infrastructure, creates additional configuration change information to minimize an effect on the application if a configuration change based on the configuration change information is made, according to the configuration change information, the IT infrastructure configuration information, and the application dependency information, creates an application effect element indicating an effect on the application if a configuration change based on the configuration change information and the additional configuration change information is made, and notifies a configuration change maker of the application effect element and the additional configuration change information.

According to the present invention, a configuration change in an IT infrastructure can be supported.

Problems, configurations, and effects other than those mentioned above will become apparent from an explanation of embodiments below.

### BRIEF DESCRIPTION OF THE DRAWINGS

FIG. 1 is a diagram depicting one schematic configuration example of a system according to the present embodiment;

FIG. 2 is an illustrative diagram of one example of hardware and functions of a configuration general management server;

FIG. 3 is a diagram depicting one example of a physical connection information management table;

FIG. 4 is a diagram depicting one example of a volume connection information management table;

FIG. 5 is a diagram depicting one example of a VM arrangement information management table;

FIG. 6 is a diagram depicting one example of an application configuration information management table;

FIG. 7 is a diagram depicting one example of an application setting file configuration-dependent information conversion table;

FIG. 8 is a diagram depicting one example of an application setting file configuration-dependent information management table;

FIG. 9 is a sequence diagram depicting one example of a configuration change process;

FIG. 10 is a sequence diagram depicting one example of an application setting change process;

FIG. 11 is a flowchart of one example of a configuration change effect calculating/additional configuration creating process;

FIG. 12 is a flowchart of one example of an application setting change recording process; and

FIG. 13 is a diagram depicting one example of an alert screen for a configuration change maker.

### DESCRIPTION OF THE PREFERRED EMBODIMENTS

Hereinafter, embodiments will be described with reference to the drawings.

In the embodiments described below, the invention will be described in a plurality of sections or embodiments when required as a matter of convenience. However, these sections or embodiments are not irrelevant to each other unless otherwise stated, and the one relates to the entire or a part of the other as a modification example, details, or a supplementary explanation thereof. Also, in the embodiments described below, when referring to the number of elements (including the number of pieces, values, amount, range, and the like), the number of the elements is not limited to a specific number unless otherwise stated or except the case where the number is apparently limited to a specific number in principle. The number larger or smaller than the specific number is also applicable.

A system or an apparatus in the present specification may be a physical computer system (one or more physical computers) or may be a system constructed on a computational resource group (a plurality of computational resources) such as a cloud platform. The computer system or computational resource group may include one or more interface devices (including a communication device and an input/output device, for example), one or more storage devices (including a memory (main storage) and an auxiliary storage device, for example), and one or more computation devices.

In a case where a function is implemented by executing a program by a computation device, the defined processing is performed with use of a storage device and/or an interface device, etc., as appropriate. Thus, the function may be at least part of the one or more computation devices. Processing explained by use of a function as a subject may be processing performed by a system including one or more computation devices.

A program may be installed from a program source. The program source may be a program distribution computer or a computer readable storage medium (e.g., a computer-readable non-transitory storage medium), for example. An explanation of each of functions is one example thereof. A plurality of these functions may be combined into one function, or one of the functions may be divided into a plurality of functions.

In one embodiment of the present specification, for a configuration change made by an IT infrastructure manager, an application effect element and a proposed additional configuration change are created and are presented to a user. An application effect element indicates zero or more application names, post configuration change operation state of an application, and setting information required to be changed before/after the configuration change of the application is made. The proposed additional configuration change indicates a change in arrangement/settings of elements constituting zero or more IT infrastructures.

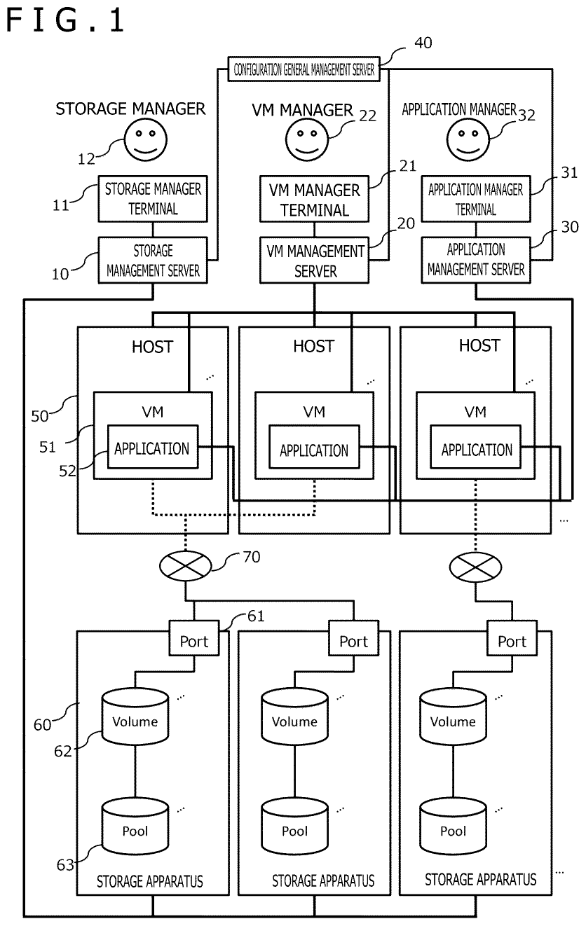

FIG. 1 is a diagram depicting one schematic configuration example of a system according to the present embodiment.

The system includes one or more hosts 50 and one or more storage apparatuses 60, and some of the hosts and apparatuses are connected via one or more storage area networks (SAN) 70.

The host 50 has one or more VMs 51 and one or more applications 52 that run on each of the VMs.

The applications 52 include an application that runs on, for example, a container orchestration tool and the like running on the VM 51.

The storage apparatus 60 has a resource pool 63 and a logical volume 62 segmented from the resource pool 63. Access from the host 50 to the logical volume 62 is allowed by fibre channel (FC)/internet small computer system interface (iSCSI) or the like. A port 61 that permits the access and an access source are written as internal settings of the storage device.

A storage manager 12 uses a storage manager terminal 11 to have access to storage management software running on a storage management server 10, and operates (e.g., monitoring, configuration change) the storage apparatus 60.

A VM manager 22 uses a VM manager terminal 21 to have access to VM management software running on a VM management server 20, and operates (e.g., monitoring, configuration change) a hypervisor on the host 50 and the VM 51 running on the hypervisor.

An application manager 32 uses an application manager terminal 31 to have access to application management software running on an application management server 30, and operates (e.g., monitoring, setting change) the application 52. The application management server may be one of the VMs 51.

A configuration general management server 40 (configuration change support apparatus) mutually communicates with the storage management server 10, the VM management server 20, and the application management server 30, and acquires IT infrastructure configuration information and application setting information, acquires configuration change information, executes an alert, and requests an additional configuration change or a setting change.

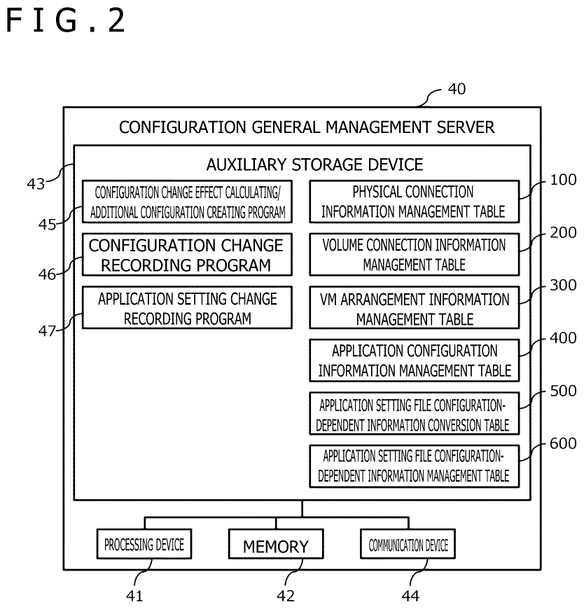

FIG. 2 is an illustrative diagram of one example of hardware and functions of the configuration general management server 40.

The configuration general management server 40 includes a processing device 41, a memory 42, an auxiliary storage device 43, and a communication device 44.

The processing device 41 includes processors such as a central processing unit (CPU), a digital signal processor (DSP), a graphics processing unit (GPU), and a field-programmable gate array (FPGA). By executing various programs stored in the auxiliary storage device 43, the processing device 41 implements an IT infrastructure constructing plan making method according to the present embodiment.

The memory 42 is called a main storage device and includes a read only memory (ROM), a random access memory (RAM), or the like. The auxiliary storage device 43 is a storage device that is auxiliary provided, and is, for example, a hard disk drive (HDD), a solid state drive (SSD), or the like. The communication device 44 includes a known network interface such as a network interface card (NIC), a wireless communication module, a universal serial interface (USB) module, or a serial communication module.

These components constituting the configuration general management server 40 can communicate with each other via an internal bus. The configuration general management server 40 may further include an input device such as a keyboard, a mouse, or a touch panel for receiving a user input operation, and an output device such as a display for displaying a processing result to a user.

A configuration change effect calculating/additional configuration creating program 45, a configuration change recording program 46, and an application setting change recording program 47 are stored in the auxiliary storage device 43 of the configuration general management server 40. A program other than those mentioned above can also be stored in the auxiliary storage device 43.

In addition, a physical connection information management table 100, a volume connection information management table 200, a VM arrangement information management table 300, an application configuration information management table 400, an application setting file configuration-dependent information conversion table 500, and an application setting file configuration-dependent information management table 600 are stored in the auxiliary storage device 43. These tables are referred to by each program being executed by the processing device 41 and are updated.

Next, details of the tables stored in the auxiliary storage device 43 of the configuration general management server 40 will be explained. In the tables which will be explained below, some of the items may be omitted, and other items may be added.

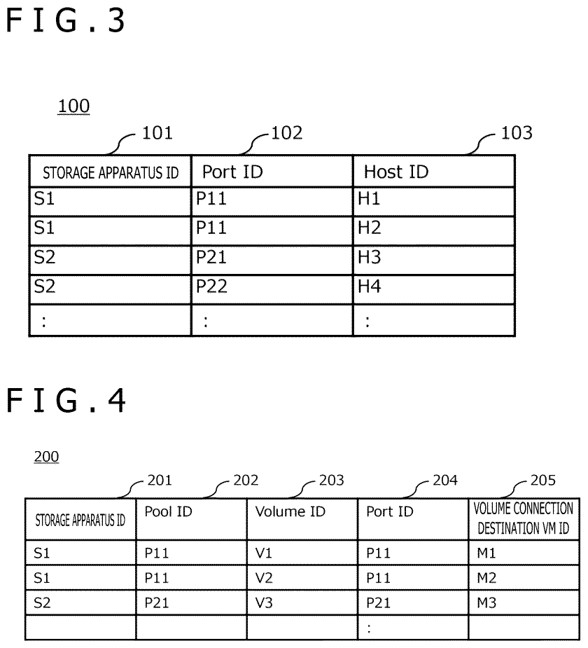

FIG. 3 is a diagram depicting one example of the physical connection information management table 100.

In the physical connection information management table 100, one record includes a storage apparatus identification (ID) 101 for identifying the storage apparatus 60, a port ID 102 for identifying the port 61 of the corresponding storage apparatus 60, and a host ID 103 for identifying the host 50 that is connected to the corresponding storage apparatus 60.

Each record indicates that the host 50 identified by the host ID 103 is connected to the storage apparatus 60 identified by the storage apparatus ID 101 via the port 61 identified by the port ID 102.

These sets of information are set by the storage manager 12 and the VM manager 22.

FIG. 4 is a diagram depicting one example of the volume connection information management table 200.

In the volume connection information management table 200, one record includes a storage apparatus ID 201 for identifying the storage apparatus 60, a pool ID 202 for identifying the resource pool 63 included in the corresponding storage apparatus 60, a volume ID 203 for identifying the logical volume 62 segmented from the resource pool 63, a port ID 204 for identifying the port 61 included in the corresponding storage apparatus 60, and a volume connection destination VM ID 205 for identifying the virtual machine 51 that is the connection destination of the corresponding logical volume 62.

Each record indicates that, to the logical volume 62 which is segmented from the resource pool 63 identified by the pool ID 202 and which is identified by the volume ID 203 on the storage apparatus 60 identified by the storage apparatus ID 201, the VM 51 of the volume connection destination VM ID 205 is connected via the port 61 identified by the port ID 204.

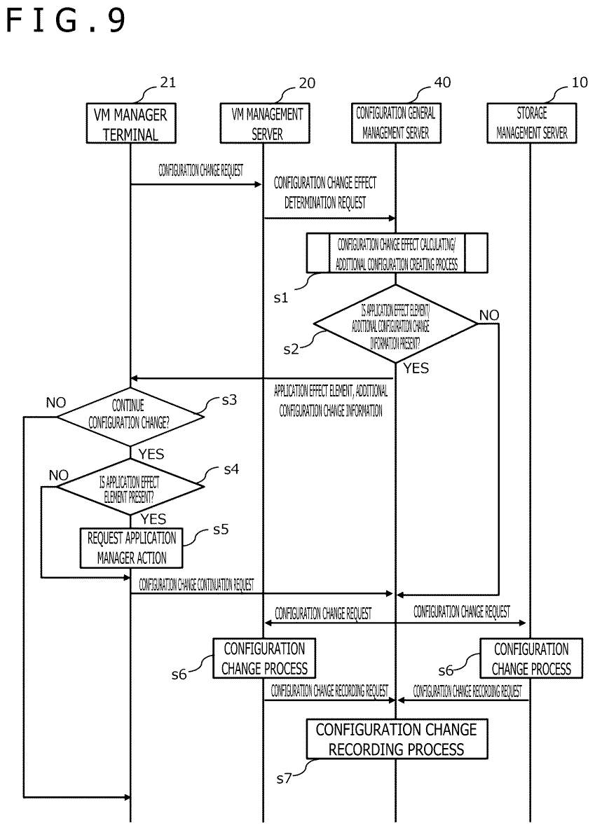

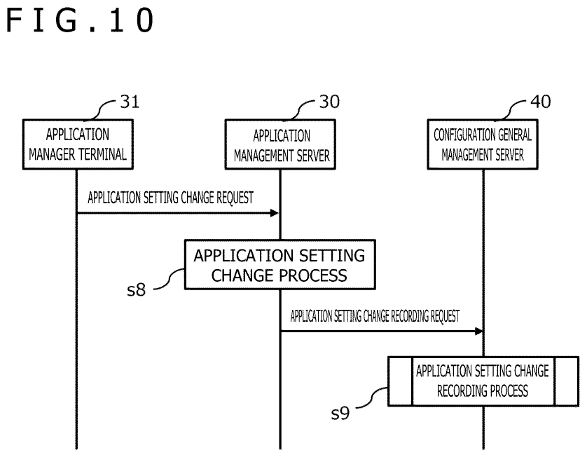

These sets of information are set in a configuration change recording process S7 in FIG. 9 which is described later.

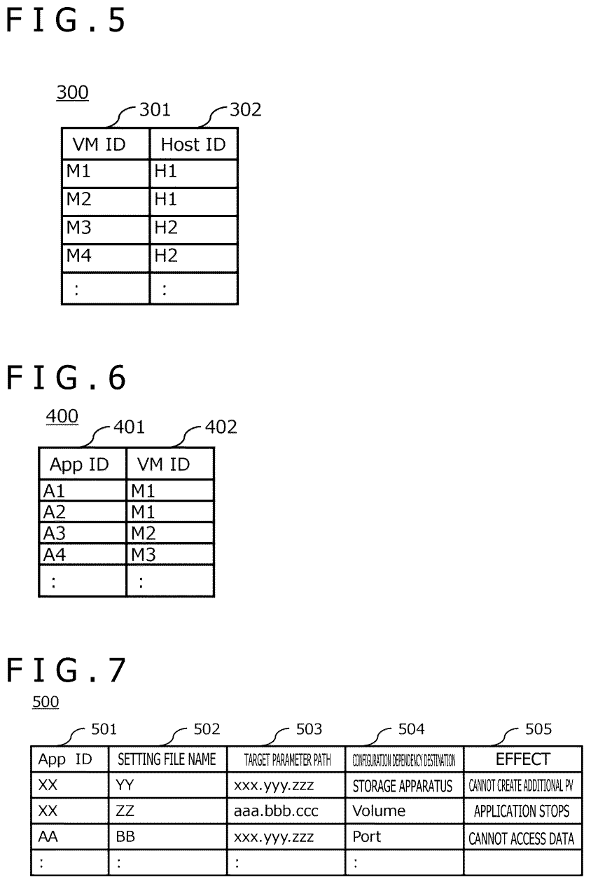

FIG. 5 is a diagram depicting one example of the VM arrangement information management table 300.

In the VM arrangement information management table 300, one record includes a VM ID 301 for identifying the virtual machine 51 and a host ID 302 for identifying the host 50 in which the corresponding VM 51 is disposed.

These sets of information are set in the configuration change recording process S7 in FIG. 9 which is described later.

FIG. 6 is a diagram depicting one example of the application configuration information management table 400.

In the application configuration information management table 400, one record includes an application ID 401 for identifying the application 52 running on the virtual machine 51, and a VM ID 402 for identifying the VM 51 to which the corresponding application 52 is deployed. These sets of information are set in the configuration change recording process S7 in FIG. 9 which is described later.

FIG. 7 is a diagram depicting one example of the application setting file configuration-dependent information conversion table 500.

In the application setting file configuration-dependent information conversion table 500, one record includes an application ID 501 for identifying the application 52, a setting file name 502 of a setting file of the corresponding application 52, a target parameter path 503 indicating a parameter path to a component that is referred to by the corresponding setting file, a configuration dependency destination 504 indicating that access to which a component in the IT infrastructure is referred to by the value of the corresponding parameter path, and an effect 505 indicating an effect on the corresponding application 52 when the corresponding access cannot be maintained.

These records are the same without being affected by any specific environment. The records may be provided by a distributor of the application 52, a distributor of application management software, a distributor of configuration general management software, etc. Alternatively, the records may be set by the application manager 32.

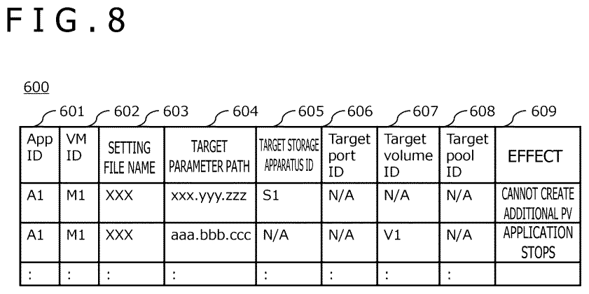

FIG. 8 is a diagram depicting one example of the application setting file configuration-dependent information management table 600.

In the application setting file configuration-dependent information management table 600, one record includes an application ID 601 for identifying the application 52, a VM ID 602 for identifying the VM 51 to which the corresponding application 52 is deployed, a setting file name 603 of a setting file of the corresponding application 52, a target parameter path 604 indicating a parameter path to a component that is referred to by the corresponding setting file, a target storage apparatus ID 605 for identifying a storage apparatus required to be accessed by the corresponding application 52, a target port ID 606 for identifying the port 61 of the storage apparatus 60 required to be accessed by the corresponding application 52, a target volume ID 607 for identifying the logical volume 62 of the storage apparatus 60 required to be accessed by the corresponding application 52, a target pool ID 608 for identifying the resource pool 63 of the storage apparatus 60 required to be accessed by the corresponding application 52, and an effect 609 indicating an effect on the application when the corresponding access cannot be maintained.

In some cases, Null is inputted in the target storage apparatus ID 605, the target port ID 606, the target volume ID 607, and the target pool ID 608, but it is guaranteed that a value other than Null is inputted in one or more columns.

These sets of information are set in an application setting change recording process S9 in FIG. 10 which is described later.

Of the abovementioned information sets held in the configuration general management server 40, information in the physical connection information management table 100, the volume connection information management table 200, the VM arrangement information management table 300, and the application configuration information management table 400 which are related to information on the IT infrastructure configuration is referred to as “IT infrastructure configuration information” while information in the application setting file configuration-dependent information management table 600, which is related to information on the dependency of the application 52 on the IT infrastructure, is referred to as “application dependency information.” Information equivalent to these sets of information may be held in a different manner from those explained in the present embodiment. For example, a format that is different in the table configuration or the like may be adopted.

Next, a process that is executed by the configuration general management server 40 will be explained.

FIG. 9 is a sequence diagram illustrating one example of a configuration change process.

An explanation of a configuration change in the VM layer by way of example will be given below, but the VM manager terminal 21 and the VM management server 20 may be replaced with the storage manager terminal 11 and the storage management server 10, respectively, and the storage management server 10 may be replaced with the VM management server 20, for a configuration change in the storage layer.

Moreover, for a setting change in the application layer, the VM manager terminal 21 and the VM management server 20 may be replaced with the application manager terminal 31 and the application management server 30, respectively.

First, configuration change information is passed from the VM manager terminal 21 to the VM management server 20, whereby a configuration change of the VM 51 is requested. Here, the configuration change information is information corresponding to one or more updates of any one of the records in the volume connection information management table 200, the VM arrangement information management table 300, and the application configuration information management table 400.

The VM management server 20 transfers the received configuration change request to the configuration general management server 40 and requests a determination of the configuration change effect.

By inputting the received configuration change information, the configuration general management server 40 executes a configuration change effect calculating/additional configuration creating process S1. First, only the purpose of this process and inputs/outputs thereof will be explained because the configuration change effect calculating/additional configuration creating process S1 will be explained in detail later.

The configuration change effect calculating/additional configuration creating process is a process of, for received configuration change information, creating additional configuration change information in such a way that dependency information in the application setting file configuration-dependent information management table 600 is maintained to a maximum extent, and calculating an effect on the application side if any.

The configuration change effect calculating/additional configuration creating process S1 is to output additional configuration change information and an application effect element. Like the configuration change information, the additional configuration change information is also information corresponding to one or more updates of any one of the records in the volume connection information management table 200, the VM arrangement information management table 300, and the application configuration information management table 400, and indicates additional configuration change information to be performed in addition to the configuration change information.

The application effect element indicates, for each application that cannot maintain the constraints in the application setting file configuration-dependent information management table 600 as a result of the configuration change, an effect on the application which is stop of the application, necessity of a change in the setting file, etc., and an altered setting file if a change in the setting file is needed.

Subsequently, whether the application effect element and the additional configuration change information are present is determined (step S2). If neither the application effect element nor the additional configuration change information is present (NO at step S2), the process proceeds to step S6 where the configuration general management server 40 executes a configuration change request to the VM management server 20 and a configuration change process.

Conversely, if at least one of the application effect element and the additional configuration change information is present (YES at step S2), the configuration general management server 40 notifies the VM manager terminal 21 of the application effect element and the additional configuration change information.

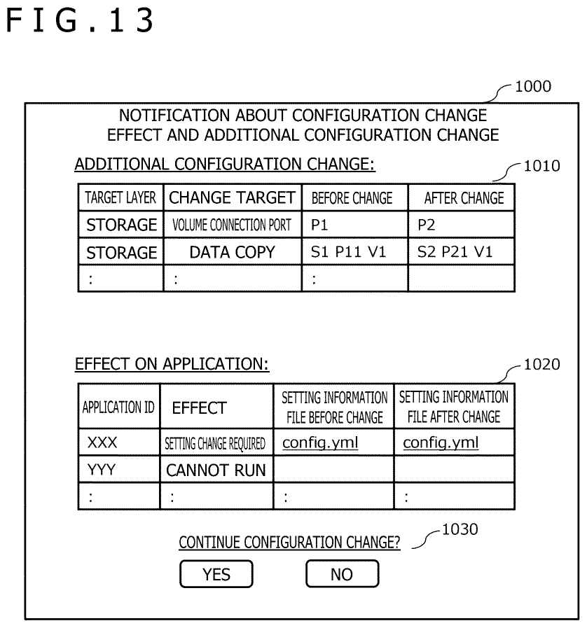

At the VM manager terminal 21, the application effect element and the additional configuration change information are displayed, and steps S3, S4, and S5 are executed. As a method of display, a graphical user interface (GUI) such as a pop-up on management software, described later with reference to FIG. 13, may be adopted, or an email, a push notification, or the like may be adopted.

Upon reception of an input from the VM manager 22 at the VM manager terminal 21, whether to continue the configuration change is determined (step S3). If it is determined not to continue the configuration change (NO at step S3), the process ends.

Conversely, if it is determined to continue the configuration change (YES at step S3), the process proceeds to step S4 and subsequent steps.

Then, whether an application effect element notified from the configuration general management server 40 is present is determined (step S4). If the application effect element notified from the configuration general management server 40 is present (YES at step S4), the process proceeds to step S5. Conversely, if an application effect element notified from the configuration general management server 40 is not present (NO at step S4), step S5 is skipped, and the subsequent steps are executed.

Subsequently, an action request to the application manager 32 is executed (step S5). Examples of the action include a manual action such as an interaction between the managers and an automatic update of the setting file. A sequence for the application configuration change will be explained later.

Subsequently, the VM manager terminal 21 executes a configuration change continuation request to the configuration general management server 40.

Subsequently, the configuration general management server 40 executes a configuration change corresponding to information written in the configuration change information and the additional configuration change information. The configuration general management server 40 passes the configuration change information and the additional configuration change information to the VM management server 20 and the storage management server 10 and requests the configuration changes.

The VM management server 20 and the storage management server 10 execute the configuration changes corresponding to the configuration change information and the additional configuration change information, respectively (step S6).

The configuration changes are attained by VM management software on the VM management server 20 and by storage management software on the storage management server 10. Any procedure can be used therefor.

Thereafter, the VM management server 20 and the storage management server 10 each execute a configuration change recording request to the configuration general management server 40. The configuration general management server 40 executes a configuration change recording process of updating the volume connection information management table 200, the VM arrangement information management table 300, and the application configuration information management table 400 on the basis of the configuration change information and the additional configuration change information (step S7). A program corresponding to this process is stored in the configuration change recording program 46 stored in the auxiliary storage device 43 of the configuration general management server 40.

Accordingly, when a configuration change is executed by the VM manager 22, a necessary additional configuration change to minimize an action to be made on the application 52 side is made, and a way to make the action to be made on the application 52 side if necessary, is calculated, in consideration of the setting information of the application 52 which makes reference to the infrastructure configuration. Thus, an alert to an infrastructure manager and presentation of these pieces of information are achieved.

It is to be noted that examples of a configuration change by the VM manager 22 include a migration of the virtual machine 51 between physical servers. In this case, there is a possibility that an event that a storage resource of configuration information included in the setting information of the application 52 on the virtual machine 51 is not accessible from a physical server that is a migration destination occurs. This is premised on a use case where, without confirming the configuration of the storage apparatus 60, the VM manager 22 tries to migrate the virtual machine 51 on the host 50 to another host 50 for the purpose of conducting maintenance of the host 50 or handling a failure in the host 50.

In addition, examples of the setting change in the application 52 include a case of constructing the virtual machine 51 and applying setting information of the existing application 52 thereto. There is a possibility that an event that a storage resource included in the setting information of the existing application 52 is not accessible from the new virtual machine 51 occurs. This is premised on a use case where the virtual machine 51 is created at the time of scale-out of the application 52, and the setting of the existing application 52 is used without being modified.

FIG. 10 is a sequence diagram depicting one example of the application setting change process.

The application manager terminal 31 executes an application setting change request to the application management server 30. The application setting change information indicates a target application ID, a setting file name, and a setting file difference.

The application management server 30 executes the application setting change process S8 of changing the corresponding application setting file. Thereafter, the application setting change information is passed to the configuration general management server, and an application setting change recording request is executed.

With the application setting change information being received as an input, the configuration general management server 40 executes the application setting change recording process S9. The application setting change recording process S9 is a process of updating the application setting file configuration-dependent information management table 600, with reference to the application setting change information and the application setting file configuration-dependent information conversion table 500. The details thereof will be explained later.

Accordingly, recording and tracking of setting information of an application which makes reference to the infrastructure configuration are achieved.

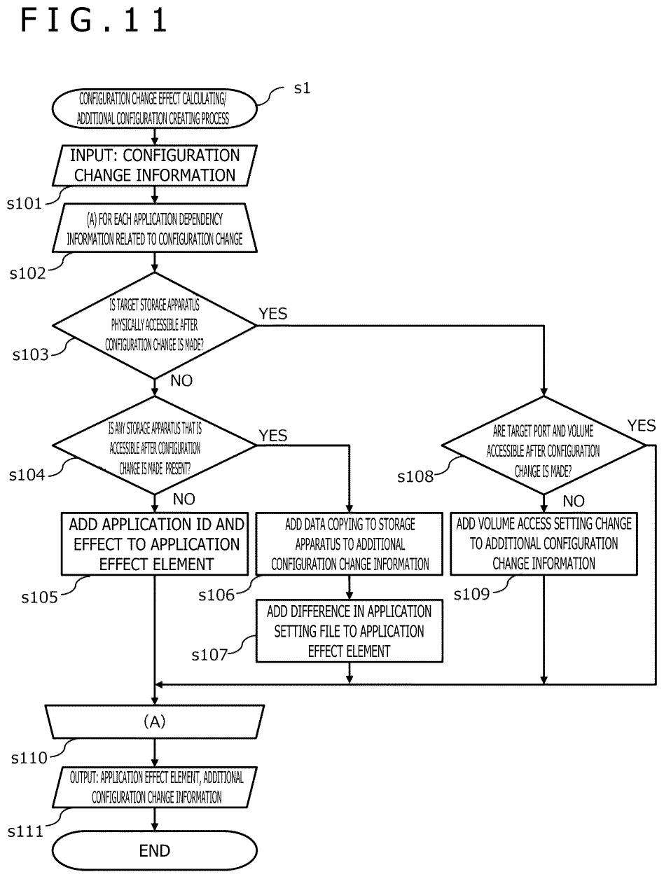

FIG. 11 is a flowchart of one example of the configuration change effect calculating/addition configuration creating process S1 in FIG. 9.

A program corresponding to this process is stored in the configuration change effect calculating/additional configuration creating program 45 stored in the auxiliary storage device 43 of the configuration general management server 40. According to the configuration change effect determination request, this process is started.

In the configuration change effect calculating/additional configuration creating process S1, the configuration general management server 40 first receives the configuration change information as an input (step S101).

As previously explained, the configuration change information is information corresponding to one or more updates of any one of the records in the volume connection information management table 200, the VM arrangement information management table 300, and the application configuration information management table 400.

Subsequently, the configuration general management server 40 acquires, from among all the records in the application setting file configuration-dependent information management table 600, a record related to the configuration change, or a configuration change-related record (application dependency information) having any one of the VM ID 602, the target storage apparatus ID 605, the target port ID 606, the target volume ID 607, and the target pool ID 608 in common with any part in the configuration change information, and repeatedly executes a series of steps S103 to S110 on each of the application dependency information. For simplification of the explanation, it is assumed that, in the subsequent steps, when the table is referred to, information corresponding to an update of a record corresponding to the configuration change information and the current additional configuration change information is preferentially used if present.

Subsequently, the configuration general management server 40 determines whether the storage apparatus 60 identified by the target storage apparatus ID 605 in the corresponding record (application dependency information) is physically accessible to the application 52 by an access method set in the application 52 after the configuration change in the configuration change information and the current additional configuration change information is made (step S103). In a specific example, the configuration general management server 40 makes reference to the VM arrangement information management table 300 for the VM ID 602 in the corresponding record, acquires the host ID 302 on which the VM 51 matching the VM ID 602 is disposed, makes reference to the physical connection information management table 100, and determines whether the storage apparatus ID 101 matching the target storage apparatus ID 605 in the corresponding record is connected to the host ID 103 matching the host ID 302.

If the storage apparatus 60 identified by the target storage apparatus ID 605 is not physically accessible to the application 52 by an access method set in the application 51 after the configuration change is made (NO at step S103), the process proceeds to step S104.

Conversely, if the storage apparatus 60 identified by the target storage apparatus ID 605 is still physically accessible to the application 52 by the access method set in the application 52 after the configuration change is made (YES at step S103), the process proceeds to step S108.

An explanation regarding a series of steps S104 to S107 is as follows.

Subsequently, the configuration general management server 40 determines whether any other storage apparatus 60 that is accessible after the configuration change is made is present (step S104). In a specific example, the configuration general management server 40 makes reference to the VM arrangement information management table 300 for the VM 51 identified by the VM ID 602 in the corresponding record, acquires the host ID 302 of the host 50 on which the VM 51 is disposed, makes reference to the physical connection information management table 100, and determines whether any storage apparatus 60 is connected to the host 50.

If any other storage apparatus 60 that is accessible after the configuration change is made is not present (NO at step S104), it is determined that an action using an additional configuration change and an application setting change cannot be performed. Then, the process proceeds to step S105.

Subsequently, the configuration general management server 40 adds a set of the application ID 601 and the effect 609 in the corresponding record to the application effect element (step S105). Then, the process proceeds to step S110.

Conversely, if any other storage apparatus 60 that is accessible after the configuration change is made is present (YES at step S104), it is determined that running of the application can be continued if data copying and an application setting change are performed, and the process proceeds to step S106.

Subsequently, the configuration general management server 40 adds information corresponding to the data copying to the other storage apparatus 60 discovered at step S104, to the additional configuration change information (step S106).

In a specific example, reference to the volume connection information management table 200 is made for the logical volume 62 identified by the target volume ID 607 in the corresponding record, and the original storage apparatus ID 201, the pool ID 202, and the port ID 204 for the logical volume 62 are acquired and changed to the storage apparatus ID of the discovered other storage apparatus 60 and the pool ID of the appropriate resource pool 63 and the port ID of the appropriate port 61 on the other storage apparatus 60. Thereafter, the process proceeds to step S107.

Subsequently, a set of the setting file name 603 of the application ID 601 in the corresponding record and a difference in the changed setting file is added to the application effect element (step S107). The difference in the changed setting file is created by replacing, for the target parameter path 604 in the corresponding record, the target storage apparatus ID 605, the target port ID 606, the target volume ID 607, and the target pool ID 608 with respective appropriate IDs on the discovered storage apparatus 60. Thereafter, the process proceeds to step S110.

Next, a series of steps S108 to S109 will be explained.

First, regarding the configuration change information and the current additional configuration change information, whether the port 61 of the target port ID 606 and the logical volume 62 of the target volume ID 607 in the corresponding record are accessible after the configuration change is made is determined (step S108).

In a specific example, with reference to the volume connection information management table 200, a list of the port IDs 204 that can be used for connection to the logical volume 62 identified by the target volume ID 607 in the corresponding record is acquired for the VM ID 602 in the corresponding record. With reference to the VM arrangement information management table 300, the host ID 302 of the host 50 on which the VM 51 identified by the VM ID 602 in the corresponding record is disposed is acquired. With reference to the physical connection information management table 100, whether the port 61 of the port ID 102 that can be used for connection to the logical volume 62 and the target port ID 606 is connected to the host 50 is determined.

If the port 61 identified by the target port ID 606 and the logical volume 62 identified by the target volume ID 607 in the corresponding record are not accessible after the configuration change is made (NO at step S108), it is determined that no effect is exerted on the application 52 if the access setting to the logical volume 62 is altered, and the process proceeds to step S109.

Subsequently, information corresponding to the volume access setting change is added to the additional configuration change information (step S109). In a specific example, in the volume connection information management table 200, the port ID 204 in a record corresponding to the volume ID 203 and the volume connection destination VM ID 205 matching the target volume ID 607 and the VM ID 602 in the corresponding record is changed to a port ID on the storage apparatus 60 in which the logical volume 62 that is accessible after the configuration change is made is present.

Conversely, if the port 61 identified by the target port ID 606 in the corresponding record and the logical volume 62 identified by the target volume ID 607 are accessible even after the configuration change is made (YES at step S108), it is determined that constraints of the corresponding record are fulfilled, whereby nothing is added. Then, the process proceeds to step S110.

Subsequently, if an unprocessed record is left in the configuration change-related record (application dependency information) acquired at step S102, the process returns to step S102 (step S110).

Then, the application effect element and the additional configuration change information which are added by the repetition of steps S102 to S110 are outputted (step S111). Accordingly, the configuration change effect calculating/additional configuration creating process S1 ends.

Accordingly, for the configuration change information given as an input, necessary additional configuration change information to minimize the action on the application 52 side and an effect element on the application 52 side when the additional configuration change is made are calculated.

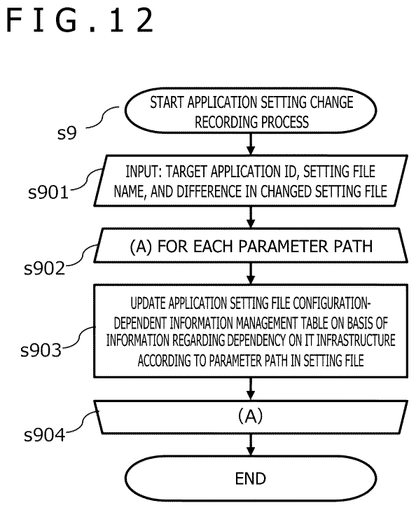

FIG. 12 is a flowchart of one example of the application setting change recording process S9 in FIG. 10.

A program corresponding to this process is stored in the application setting change recording program 47 stored in the auxiliary storage device 43 of the configuration general management server 40. According to the application setting change recording request, this process is started.

In the application setting change recording process S9, first, the target application ID, the setting file name, and the difference in the changed setting file in the application setting change information are received as an input (step S901).

Thereafter, step S903 is repeated for each parameter path of the difference in the changed setting file. (step S902).

Subsequently, the application setting file configuration-dependent information management table 600 is updated on the basis of the information regarding the dependency on the IT infrastructure according to the parameter path in the setting file (step S903).

In a specific example, with reference to the application setting file configuration-dependent information conversion table 500, if a record in which information corresponding to the application ID, the setting file name, and the parameter path is written as the application ID 501, the setting file name 502, and the target parameter path 503 is not present, the application setting file configuration-dependent information management table 600 is not updated.

If a record in which information corresponding to the application ID, the setting file name, and the parameter path is written as the application ID 501, the setting file name 502, and the target parameter path 503 is present, with reference to the application configuration information management table 400, the VM ID 402 of the VM 51 to which the application 52 of the corresponding application ID is deployed is acquired, the target storage apparatus ID 605, the target port ID 606, the target volume ID 607, and the target pool ID 608 are acquired from the values defined in the configuration dependency destination 504 and the target parameter path 503, and a new record is added (a record is deleted if the setting file difference indicates deletion) to the application setting file configuration-dependent information management table 600.

Subsequently, if an unprocessed parameter path is left in the difference in the changed setting file, the process returns to step S902 (step S904). If any unprocessed parameter path is not left, the application setting change recording process S9 ends.

FIG. 13 is a diagram depicting one example of an alert screen for a configuration change maker 1000 that is displayed on a terminal (VM manager terminal 21 or storage manager terminal 11) of a configuration change maker (VM manager 22 or storage manager 12).

The alert screen for a configuration change maker 1000 includes an additional configuration change display area 1010 where additional configuration change information created by the configuration change effect calculating/additional configuration creating process S1 is displayed, an application effect element display area 1020 where an application effect element created by the configuration change effect calculating/additional configuration creating process S1 as well is displayed, and a check area 1030 where whether or not to continue the configuration change while making the displayed additional configuration change and the application setting change is inputted by a user.

Accordingly, the configuration change maker (VM manager 22 or storage manager 12) can check the effect of the configuration change on the application and a necessary additional configuration change to minimize the effect on the application.

It is to be noted that the information in FIG. 13 may partially be omitted and any other information not depicted in FIG. 13 may be presented.

The contents of the additional configuration change information are displayed in the additional configuration change display area 1010. The contents may be displayed in a table format as depicted in the drawing, or may be outputted as a file, for example.

The contents of the application effect elements are displayed in the application effect element display area 1020. The contents may be displayed in a table format as depicted in the drawing, or may be outputted as a file, for example. Further, a change in the setting file may be outputted as a file as depicted in the drawing or may be described in a text format in the area.

In the check area 1030, a user's input about whether to continue the configuration change is received. This input corresponds to step S3 of checking whether to continue the configuration change in FIG. 9.

It is to be noted that the present invention is not limited to the abovementioned embodiments and includes various modifications. For example, the abovementioned embodiments have been described in detail for better understandings of the present invention, and thus, the present invention is not necessarily limited to an embodiment that includes all the features described above. Moreover, part of a configuration of one of the embodiments can be replaced with a configuration of another embodiment, or a configuration of one of the embodiments can also be added to a configuration of another embodiment. Also, addition, deletion, or replacement of part of a configuration of each of the embodiments can be made.

Moreover, the abovementioned configurations, functions, processing units, etc., may be implemented by hardware by, for example, designing part or all thereof on an integrated circuit (IC). In addition, the abovementioned configurations, functions, etc., may be implemented by software by, for example, interpreting and executing programs to cause a processor to implement respective functions. Information on the programs for implementing the respective functions, a table, a file, etc., can be stored in a recording device such as a memory, a hard disk, or a solid state drive, or in a recording medium such as an IC card or a secure digital (SD) card.

In addition, a control line and an information line illustrated here are considered to be necessary for the explanation, and thus, al control lines or information lines required for products are not necessarily illustrated. It can be considered that almost all the configurations are mutually connected in actual use.

What is claimed is:

1. A configuration change support apparatus for supporting a configuration change in an information technology infrastructure including one or more storage apparatuses and one or more hosts each connected with the storage apparatus, the information technology infrastructure being abbreviated as IT hereinafter, the configuration change support apparatus comprising:
a storage device; and
a processing device, wherein
the storage device stores
IT infrastructure configuration information indicating physical connection and logical connection in the IT infrastructure and arrangement information of resources constituting the IT infrastructure, and
application dependency information indicating dependency of an application being executed by the host on the IT infrastructure, and
the processing device
acquires configuration change information on the IT infrastructure,
creates additional configuration change information to minimize an effect on the application if a configuration change based on the configuration change information is made, according to the configuration change information, the IT infrastructure configuration information, and the application dependency information,
creates an application effect element indicating an effect on the application if a configuration change based on the configuration change information and the additional configuration change information is made, and
notifies a configuration change maker of the application effect element and the additional configuration change information.

2. The configuration change support apparatus according to claim 1, wherein
the storage device
includes a conversion table of a setting file of the application to configuration dependent information, and
the processing device
updates the application dependency information according to the conversion table when the setting file of the application is changed.

3. The configuration change support apparatus according to claim 2, wherein,
when a configuration change in the IT infrastructure is made, the processing device records the configuration change in the IT infrastructure configuration information.

4. The configuration change support apparatus according to claim 2, wherein,
in a case where physical connection to a virtual machine on which the application runs and the storage apparatus connected with the host is lost after a configuration change in the IT infrastructure is made, the processing device
creates additional configuration change information to perform data copying to another storage apparatus that the application can be connected to after the IT infrastructure configuration change is made, and
creates an application effect element to indicate a difference in the setting file of the application when a change for allowing access to the other storage apparatus is made.

5. The configuration change support apparatus according to claim 2, wherein,
if, after the configuration change in the IT infrastructure is made, the application becomes unable to access the storage apparatus that the application has accessed by a method for accessing the storage apparatus set in the application, the processing device creates the additional configuration change information to make a setting change of the storage apparatus in such a manner as to permit the access using the accessing method.

6. The configuration change support apparatus according to claim 2, wherein,
in a case where physical connection to a virtual machine on which the application runs and the storage apparatus connected with the host is lost after the configuration change in the IT infrastructure is made,
the processing device creates an application effect element to indicate an effect on running of the application, if any other storage apparatus that the application can be connected to after the configuration change in the IT infrastructure is made is not present.

7. The configuration change support apparatus according to claim 2, wherein,
after notifying the configuration change maker of the application effect element and the additional configuration change information, the processing device receives an input about whether or not to continue the configuration change in the IT infrastructure from the configuration change maker, and,
when receiving a selection to continue the configuration change, the processing device requests a configuration change based on the configuration change information and the additional configuration change information, to a corresponding management server in the IT infrastructure.

8. A configuration change support method of a configuration change support apparatus that supports a configuration change in an information technology infrastructure including one or more storage apparatuses and one or more hosts each connected with the storage apparatus, the information technology infrastructure being abbreviated as IT hereinafter,
the configuration change support apparatus including
a storage device, and
a processing device, wherein
the storage device stores
IT infrastructure configuration information indicating physical connection and logical connection in the IT infrastructure and arrangement information of resources constituting the IT infrastructure, and
application dependency information indicating dependency of an application being executed by the host on the IT infrastructure, and
the processing device
acquires configuration change information on the IT infrastructure,
creates additional configuration change information to minimize an effect on the application if a configuration change based on the configuration change information is made, according to the configuration change information, the IT infrastructure configuration information, and the application dependency information,
creates an application effect element indicating an effect on the application if a configuration change based on the configuration change information and the additional configuration change information is made, and
notifies a configuration change maker of the application effect element and the additional configuration change information.

9. The configuration change support method according to claim 8, wherein,
the storage device
includes a conversion table of a setting file of the application to configuration dependent information, and
the processing device
updates the application dependency information according to the conversion table when the setting file of the application is changed.

10. The configuration change support method according to claim 9, wherein,
when a configuration change in the IT infrastructure is made, the processing device records the configuration change in the IT infrastructure configuration information.

11. The configuration change support method according to claim 9, wherein,
in a case where physical connection to a virtual machine on which the application runs and the storage apparatus connected with the host is lost after a configuration change in the IT infrastructure is made, the processing device
creates additional configuration change information to perform data copying to another storage apparatus that the application can be connected to after the IT infrastructure configuration change is made, and
creates an application effect element to indicate a difference in the setting file of the application when a change for allowing access to the other storage apparatus is made.

12. The configuration change support method according to claim 9, wherein,
if, after the configuration change in the IT infrastructure is made, the application becomes unable to access the storage apparatus that the application has accessed by a method for accessing the storage apparatus set in the application, the processing device creates the additional configuration change information to make a setting change of the storage apparatus so as to permit the access using the accessing method.

13. The configuration change support method according to claim 9, wherein,
in a case where physical connection to a virtual machine on which the application runs and the storage apparatus connected with the host is lost after the configuration change in the IT infrastructure is made,
the processing device creates an application effect element to indicate an effect on running of the application, if any other storage apparatus that the application can be connected to after the configuration change in the IT infrastructure is made is not present.

14. The configuration change support method according to claim 9, wherein,
after notifying the configuration change maker of the application effect element and the additional configuration change information, the processing device receives an input about whether or not to continue the configuration change in the IT infrastructure from the configuration change maker, and,
when receiving a selection to continue the configuration change, the processing device requests a configuration change based on the configuration change information and the additional configuration change information, to a corresponding management server in the IT infrastructure.
